(19) United States
(12) Patent Application Publication
(10) Pub. No.: US 2014/0084808 A1
(43) Pub. Date: Mar. 27, 2014

(54) MOUNTED LIGHTING SYSTEMS AND METHODS

(71) Applicant: Andrew Kavovit, Studio City, CA (US)

(72) Inventor: Andrew Kavovit, Studio City, CA (US)

(21) Appl. No.: 14/036,804

(22) Filed: Sep. 25, 2013

Related U.S. Application Data
(60) Provisional application No. 61/705,872, filed on Sep. 26, 2012.

(51) Int. Cl. H05B 37/02

(52) U.S. Cl. CPC H05B 37/02
USPC 315/291

(57) ABSTRACT

In one exemplary embodiment, a mounted lighting system may be described. The mounted lighting system may include a central processing module electrically and/or communicatively coupled to at least one light army, and electrically and/or communicatively coupled to a control module. The control module may receive remote signals that activate and provide a visual pattern amongst the lights on the light array.

### BACKGROUND

Conventional lighting systems, such as holiday lighting systems, are strands of electric lights used to decorate buildings and other structures during holiday seasons. These lighting systems typically provide lighting patterns of varying types, depending on the configuration of light bulbs used, and on their type and color.

Conventional lighting systems present practical inconveniences, as well as safety-related problems. First, these systems are typically bulky and entail cumbersome wiring for power. Moreover, holidays usually take place during short, isolated periods of the year. As a results, conventional lighting systems typically require regular installation and uninstallation, so as not to be left up unused for most of the year. During holiday seasons, they are however undesirably visible during the day. Furthermore, options for customizing lighting patterns are usually limited or not available.

### SUMMARY

In one exemplary embodiment, a mounted lighting system may be described. The mounted lighting system may include a central processing module electrically and/or communicatively coupled to at least one light array, and electrically and/or communicatively coupled to a control module. The control module may receive remote signals that activate and provide a visual pattern amongst the lights on the light array.

In another exemplary embodiment, a method for controlling a light array may be described. The method can include coupling a plurality of lights in an array to a control module; powering the control module and the plurality of lights; sending a signal related to a visual pattern to the control module from a remote location; and providing the visual pattern amongst the plurality of lights by the control module after receipt of the signal.

### BRIEF DESCRIPTION OF THE DRAWINGS

The present embodiments are illustrated by way of example and not limitation in the figures of the accompanying drawings, in which like references indicate similar elements.

FIG. 1 illustrates an exemplary embodiment of a computer system.

FIG. 2 illustrates an exemplary embodiment of a mounted lighting system.

FIG. 3 illustrates an exemplary embodiment of a light array.

FIG. 4 illustrates an exemplary embodiment of a control module.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Embodiments disclosed herein may provide mounted lighting systems and methods. Some exemplary embodiments may provide streamlined and minimally visible lighting systems. Other exemplary embodiments may not require regular installation and uninstallation. Yet other exemplary embodiments may offer a high degree of lighting pattern customization.

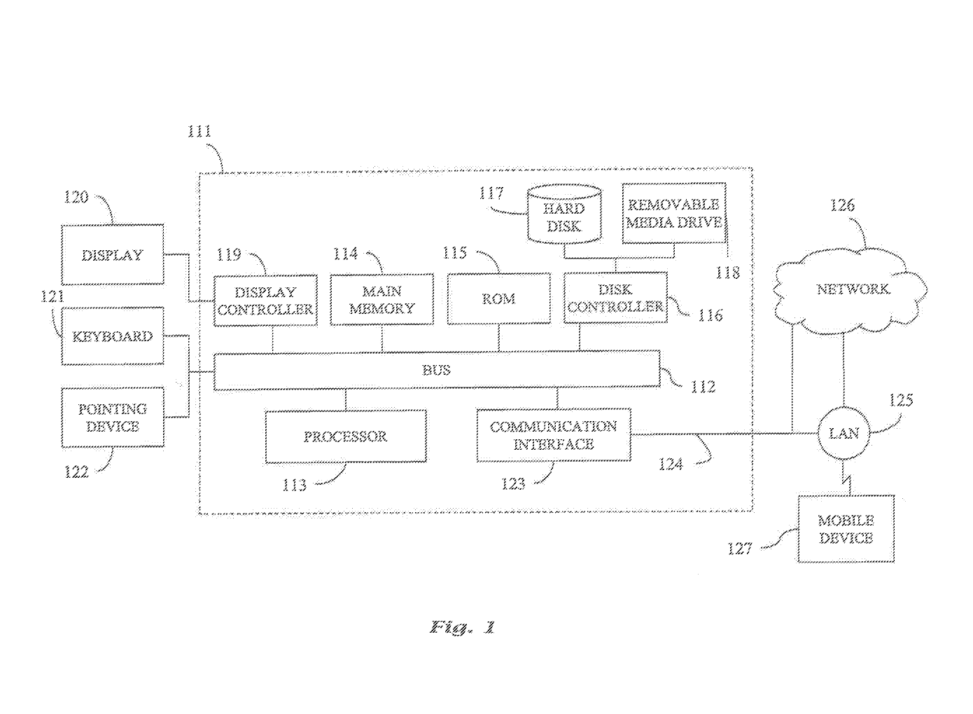

FIG. 1 illustrates a computer system 111 upon which an exemplary embodiment of the present invention may be implemented. The computer system 111 may include a bus 112 or other communication mechanism for communicating information, and a processor 113 coupled with the bus 112 for processing the information. The computer system 111 also may include a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 may further include a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 may also include a disk controller 116 coupled to the bus 112 to control one or more storage devices for storing information and instructions, such as a magnetic hard disk 117, and a removable media drive 118 (e.g., floppy disk drive, flash memory drive, read-only compact disc drive, read/write compact disc drive, compact disc jukebox, tape drive, and removable magneto-optical drive). The storage devices may be added to the computer system 111 using an appropriate device interface, including, for example, a small computer system interface (SCSI), integrated device electronics (IDE), enhanced-IDE (E-IDE), direct memory access (DMA), ultra-DMA, a serial port connection, a parallel port connection, USB, IEEE 1394 (FireWire), Bluetooth, Wi-Fi, or any other type of connection or interface known in the art.

The computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system may include input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 may perform a portion or all of the processing steps of exemplary embodiments of the invention in response to the processor 113 executing one or more sequences of one or more instructions contained in a memory, such as the main memory 114. Such instructions may be read into the main memory 114 from another computer-readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 may include at least one computer-readable medium or memory for holding instructions programmed according to the teachings of exemplary embodiments of the invention and for containing data structures, tables, records, or other data described herein. Examples of computer-readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer-readable media, exemplary embodiments of the present invention may include software for controlling the computer system 111, for driving a device or devices for implementing exemplary embodiments of the invention, and for enabling the computer system 111 to interact with a human user. Such software may include, but is not limited to, device drivers, operating systems, development tools, and applications software. Such computer-readable media may further include the computer program product of exemplary embodiments of the present invention for performing all or a portion (if processing is distributed) of the processing performed in implementing exemplary embodiments of the invention.

The computer code devices of exemplary embodiments of the present invention may be any interpretable or executable code mechanism, including but not limited to scripts, interpretable programs, dynamic link libraries (DLLs), Java classes, and complete executable programs. Moreover, parts of the processing of exemplary embodiments of the present invention may be distributed for better performance, reliability, and/or cost.

The term “computer-readable medium” as used herein refers to any medium that may participate in providing instructions to the processor 113 for execution. A computer-readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media may include dynamic memory, such as the main memory 114. Transmission media may include coaxial cables, copper wire and fiber optics, including the wires that make up the bus 112. Transmission media also may also take the form of acoustic or light waves, such as those generated during radio wave and infrared data communications. Transmission may be accomplished using, for example, a serial port connection, a parallel port connection, USB, IEEE 1394 (FireWire), Bluetooth, Wi-Fi, or any other type of connection or interface known in the art.

Various forms of computer-readable media may be involved in carrying out one or more sequences of one or more instructions to processor 113 for execution. For example, the instructions may initially be carried on a magnetic disk of a remote computer. The remote computer can load the instructions for implementing all or a portion of exemplary embodiments of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 may carry the data to the main memory 114, from which the processor 113 may retrieve and execute the instructions. The instructions received by the main memory 114 may optionally be stored on storage device 117 or 118 either before or after execution by processor 113.

The computer system 111 may also include a communication interface 123 coupled to the bus 112. The communication interface 123 may provide a two-way data communication coupling to a network link 124 that may be connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links, using, for example, Wi-Fi or Bluetooth, may also be implemented. In any such implementation, the communication interface 123 may send and receive electrical, electromagnetic or optical signals that may carry digital data streams representing various types of information.

The network link 124 typically may provide data communication through one or more networks to other data devices. For example, the network link 124 may provide a connection to another computer or remotely located presentation device through a local network 125 (e.g., a LAN) or through equipment operated by a service provider, which may provide communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of exemplary embodiments of the invention may include data transmission and Internet-related activities. See Preston Gralla, How the Internet Works, Ziff-Davis Press (1996), which is hereby incorporated by reference into this patent application. Still other aspects of exemplary embodiments of the invention may utilize wireless data transmission, such as those described in U.S. Pat. Nos. 6,456,645, 5,818,328 and/or 6,208,445, all of which are hereby incorporated by reference into this patent application.

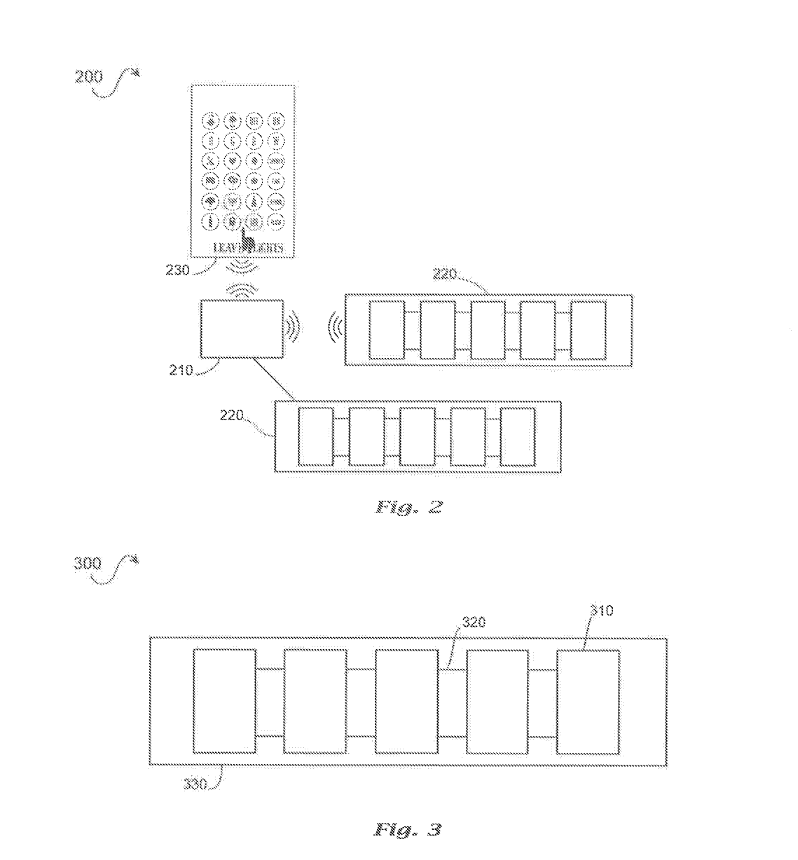

FIG. 2 shows an exemplary embodiment of a mounted lighting system 200, which may include a central processing module 210 electrically and/or communicatively coupled to at least one light array 220, and electrically and/or communicatively coupled to a control module 230. The central processing module 210 may include a programmable processor adapted to control lighting characteristics of the light array(s) 220. The processor of the central processing module 210 may be pre-programmed and/or re-programmable. Pre-programming may allow for a mounted lighting system to be used continuously and in a variety of circumstances, for example to display visual patterns or visual cues related to different holidays. In other exemplary embodiments, a light array may include a processor adapted to perform operations to control light patterns. In yet other exemplary embodiments, a control module may include a processor to interact with a user and/or perform operations to control light patterns.

FIG. 3 shows an exemplary embodiment of a light array 300, which may include one or more lights 310, electrical connections 320, and a light support 330. A light array may be adapted to be coupled to a structure to be lit. The lights may be of various types. The lights may have varying distances between them. Some possible embodiments may have a distance of about 4″-7″ between lights, although any desirable variation in distance may be provided. Utilizing lights with an extended lifetime may allow a user to install a mounted lighting system once on a structure, with minimal or no need for regular maintenance. Such light utilized in any lighting array can be any desired types of lights, for example, but not limited to, light emitting diodes (LEDs). Lights, light connections and/or light supports may be adapted to be minimally visible when coupled to a structure to be lit. For example, lights may be substantially flat, and their support may be camouflaged to resemble the structure to be lit. For example, an exemplary light array may be adapted to resemble or otherwise blend with the trim of a building in a camouflaged fashion. In some exemplary embodiments, the light connections and the light support may be integrated as one piece.

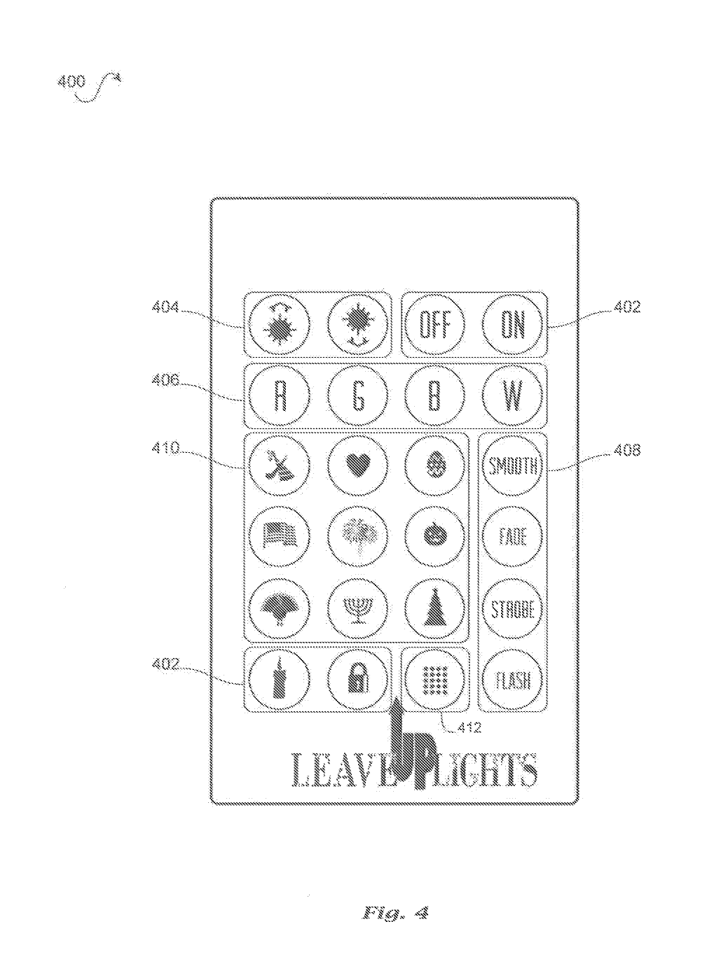

FIG. 4 snows an exemplary embodiment of a remote control module 400, which may be implemented as a button-equipped or otherwise tactile remote control, a graphical user interface (GUI) on a computer system, a wall-mounted control unit, or any other control modules which may be known to a person of ordinary skill us the art. The control module may communicate with or be otherwise electrically coupled to a central processing module in a wireless manner, and may be adapted to produce changes in lighting characteristics of at least one light array. The control module may include any of power control 402, brightness control 404, color control 406, sequence control 408, preprogrammed control 410, and reset control 412.

A power control 402 may be used to turn a mounted lighting system on or off. Further, a power control 402 may provide sleep or hibernation options, and locking or other security options. A brightness control 404 may be used to adjust the brightness of a mounted lighting system. A color control 406 may be used to select preset color or visual patterns for a mounted lighting system. A sequence control 408 may be used to select preset lighting sequence patterns for a mounted sighting system. A preprogrammed control 410 may be used to select preset lighting color and sequence patterns for a mounted lighting system. A preset lighting color and sequence pattern, or any other visual pattern, may correspond to a specific holiday or type of event. A reset control 412 may be used to reset a mounted lighting system to an initial preset lighting pattern.

Such controls, as described in exemplary FIG. 4, may be utilized together or separately and may allow for combinations of visual patterns to be displayed on a lighting array. Additionally, control module may be used in conjunction with any desired form of software that may allow for the programming or customization of any desired lighting pattern, power timing and control, sound or audio synchronization with a desired lighting pattern or display, and the like.

An exemplary method for operating a mounted lighting system may include obtaining a central processing module electrically and/or communicatively coupled to at least one light array, and electrically and/or communicatively coupled to a control module. Exemplary central processing modules, light arrays, and control modules may have characteristics substantially similar to those of exemplary central processing modules, light arrays and control modules described in exemplary FIG. 1-4.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A light display system comprising:
one or more central processing modules;
one or more light arrays;
one or more control modules; and
a remote control that controls the light display system.

2. A light display system as in claim 1, wherein a light array further comprises light emitting diodes.

3. A light display system as in claim 1, wherein a computer system acts as a control module for the system in claim 1.

4. A light display system as in claim 1, wherein a central processing module contains a circuit which when used causes changes to a visual pattern displayed by a light array.

5. A light display as in claim 1, wherein the changes to the visual pattern displayed by the light array are at least one of activating the light emitting diodes and changing colors of the light emitting diodes.

6. A light display system as in claim 1, wherein a control module further comprises an interface which allows for selection of a visual pattern and directs a central processing module to reproduce a selected visual pattern.

7. A light display system as in claim 6, wherein the interface is provided on a remote control.

8. A light display system as in claim 6, wherein the interface is provided on a computer display.

9. A light display system as in claim 1, wherein the remote control is wireless.

10. A light display system as in claim 1, wherein a central processing module makes the light array reproduce a predetermined visual pattern.

11. A light display system as in claim 10, wherein an interface allows for selection of a set of visual patterns to be reproduced in a chosen sequence on the light array.

12. A light display system as in claim 1, wherein the light array is weatherproof.

13. A light display system as in claim 1 wherein the light array is camouflaged so as to not be readily visible when not powered.

14. A light display device embodying a system as in claim 1, wherein the control module is physically coupled to the light array.

15. A method of controlling a light array, comprising:
coupling a plurality of lights to a control module;
powering the control module and the plurality of lights;
sending a signal related to a visual pattern to the control module from a remote location; and
providing the visual pattern amongst the plurality of lights by the control module after receipt of the signal.

16. The method of controlling a light array of claim 15, wherein the visual pattern is a predetermined visual pattern.

17. The method of controlling a light array of claim 15, wherein the visual pattern is generated on an interface.

18. The method of controlling a light array of claim 15, wherein the signal is sent from a remote control.
